(19) United States
(12) Patent Application Publication
(10) Pub. No.: US 2014/0033690 A1
(43) Pub. Date: Feb. 6, 2014

(54) MACHINE HYDRAULIC SYSTEM HAVING FINE CONTROL MODE

(71) Applicants: Bryan J. Hillman, Peoria, IL (US); Lawrence J. Tognetti, Peoria, IL (US); Rustu Cesur, Lombard, IL (US)

(72) Inventors: Bryan J. Hillman, Peoria, IL (US); Lawrence J. Tognetti, Peoria, IL (US); Rustu Cesur, Lombard, IL (US)

(21) Appl. No.: 13/562,864

(22) Filed: Jul. 31, 2012

(51) Int. Cl. F15B 13/00; F16K 31/12

(52) U.S. Cl. 60/327; 251/12

(57) ABSTRACT

A hydraulic system for a machine is disclosed. The hydraulic system may have a hydraulic actuator, and at least one valve configured to regulate fluid flows associated with the hydraulic actuator. The hydraulic system may also have an operator interface device configured to generate a position signal indicative of a desired movement velocity of the hydraulic actuator, a mode switch movable to generate a mode signal indicative of desired operation in one of a normal control mode and a fine control mode, and a controller. The controller may be configured to move the at least one valve to a first position based on the position signal when the mode signal indicates desired operation in the normal mode, and to move the at least one valve to a second position based on the position signal when the mode signal indicates desired operation in the fine control mode.

### TECHNICAL FIELD

The present disclosure relates generally to a machine hydraulic system, and more particularly, to a machine hydraulic system having a fine control mode of operation.

### BACKGROUND

Machines such as excavators, draglines, cranes, loaders, and other types of heavy equipment use one or more hydraulic actuators to move a work tool. These actuators are fluidly connected to a pump on the machine that provides pressurized fluid to chambers within the actuators. As the pressurized fluid moves into or through the chambers, the pressure of the fluid acts on hydraulic surfaces of the chambers to affect movement of the actuator and the connected work tool. When the pressurized fluid is drained from the chambers, it is returned to a low pressure sump or accumulator on the machine. An exemplary hydraulic arrangement for a machine is disclosed in U.S. Pat. No. 7,908,852 that issued to Zhang et al. on Mar. 22, 2011.

One problem associated with conventional hydraulic arrangements involves fine control over machine movements. In particular, the fluid filling and draining from the actuator chambers is directed to flow into and out of the actuator at one particular rate corresponding to the position of the operator input device (e.g., a joystick). This particular rate may be intended primarily to facilitate production and/or efficiency of the machine. Although adequate for most situations, this one particular rate may not provide the fine control necessary for other situations.

The disclosed hydraulic system is directed to overcoming one or more of the problems set forth above and/or other problems known in the art.

### SUMMARY

One aspect of the present disclosure is directed to a hydraulic system for a machine. The hydraulic system may include a hydraulic actuator having a first chamber and a second chamber, and at least one valve configured to regulate fluid flows associated with the first and second chambers. The hydraulic system may also include an operator interface device movable through a range from a neutral position to a maximum displaced position to generate a corresponding position signal indicative of a desired velocity of the hydraulic actuator. The hydraulic system may further include a mode switch movable to generate a mode signal indicative of desired operation in one of a normal control mode and a fine control mode, and a controller in communication with the at least one valve, the operator interface device, and the mode switch. The controller may be configured to move the at least one valve to a first position based on the position signal when the mode signal indicates desired operation in the normal mode, and to move the at least one valve to a second position based on the position signal when the mode signal indicates desired operation in the fine control mode.

Another aspect of the present disclosure is directed to a method of controlling a hydraulic tool of a machine. The method may include receiving a first operator input indicative of a desired velocity of the work tool, and receiving a second operator input indicative of desired operation in one of a normal control mode and a fine control mode. The method may also include moving at least one control valve associated with fluid flow of an actuator of the hydraulic tool to a first position based on the first operator input when the second operator input is indicative of desired operation in the normal control mode. The method may further include moving at least one control valve to a second position based on the first operator input when the second operator input is indicative of desired operation in the fine control mode.

### BRIEF DESCRIPTION OF THE DRAWINGS

FIG. 1 is a diagrammatic illustration of an exemplary disclosed machine; and

FIG. 2 is a schematic illustration of an exemplary disclosed hydraulic system that may be used with the machine of FIG. 1.

### DETAILED DESCRIPTION

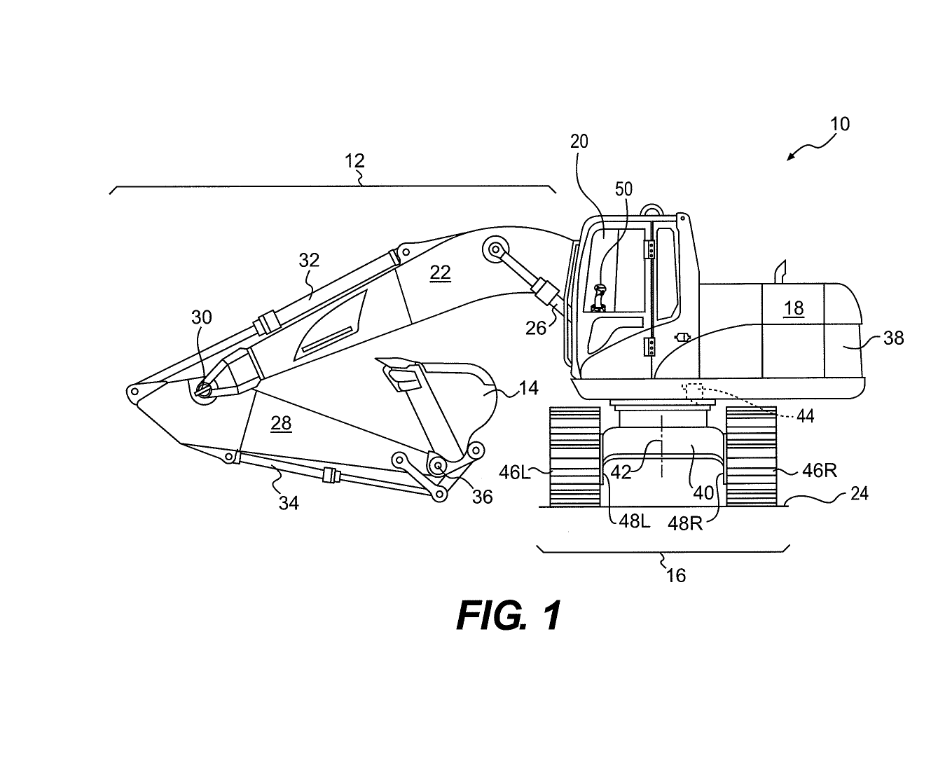

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as an excavator (shown in FIG. 1), a dragline, a front shovel, a backhoe, or another earth moving machine. Machine 10 may include an implement system 12 configured to move a work tool 14, a drive system 16 for propelling machine 10, and a power source 18 that provides power to implement system 12 and drive system 16. Machine 10 may also include an operator station 20 for manual control of implement system 12 and/or drive system 16.

Implement system 12 may include linkage structure acted on by fluid actuators to move work tool 14. Specifically, implement system 12 may include a boom 22 that is vertically pivotal about a horizontal axis (not shown) relative to a work surface 24 by a pair of adjacent, double-acting, hydraulic cylinders 26 (only one shown in FIG. 1). Implement system 12 may also include a stick 28 that is vertically pivotal about a horizontal axis 30 by a single, double-acting, hydraulic cylinder 32. Implement system 12 may further include a single, double-acting, hydraulic cylinder 34 operatively connected between stick 28 and work tool 14 to pivot work tool 14 vertically about a horizontal pivot axis 36. Boom 22 may be pivotally connected to a body 38 of machine 10. Body 38 may be pivoted relative to an undercarriage 40 about a vertical axis 42 by a hydraulic swing motor 44. Stick 28 may pivotally connect boom 22 to work tool 14 by way of axis 30 and 36. It should be noted that other configurations of implement system 12 may also be possible.

Each of hydraulic cylinders 26, 32, and 34 may include a tube and a piston assembly (not shown) arranged to form two separated pressure chambers (e.g., a head chamber and a rod chamber). The pressure chambers may be selectively supplied with pressurized fluid and drained of the pressurized fluid to cause the piston assembly to displace within the tube, thereby changing an effective length of hydraulic cylinders 26, 32, 34. The flow rate of fluid into and out of the pressure chambers may relate to a velocity of hydraulic cylinders 26, 32, 34, while a pressure differential between the two pressure chambers may relate to a force imparted by hydraulic cylinders 26, 32, 34 on the associated linkage members. The expansion and retraction of hydraulic cylinders 26, 32, 34 may function to move work tool 14.

Swing motor 44, like hydraulic cylinders 26, 32, 34, may be driven by a fluid pressure differential. Specifically, swing motor 44 may include first and second chambers (not shown) located to either side of an impeller (not shown). When the first chamber is filled with pressurized fluid and the second chamber is drained of fluid, the impeller may be urged to rotate in a first direction. Conversely, when the first chamber is drained of fluid and the second chamber is filled with pressurized fluid, the impeller may be urged to rotate in an opposite direction. The flow rate of fluid into and out of the first and second chambers may determine a rotational velocity of swing motor 44 and/or work tool 14, while a pressure differential across the impeller may determine an output torque and/or acceleration of swing motor 44 and/or work tool 14.

Numerous different work tools 14 may be attachable to a single machine 10 and operator controllable. Work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 38 of machine 10 and to swing in the horizontal direction relative to undercarriage 40, work tool 14 may alternatively or additionally rotate, slide, open/close, or move in any other manner known in the art.

Drive system 16 may include one or more traction devices powered to propel machine 10. In the disclosed example, drive system 16 includes a left track 46L located on one side of machine 10, and a right track 46R located on an opposing side of machine 10. Left track 46L may be driven by a left travel motor 48L, while right track 46R may be driven by a right travel motor 48R. It is contemplated that drive system 16 could alternatively include traction devices other than tracks such as wheels, belts, or other known traction devices. Machine 10 may be steered by generating a velocity and or rotational direction difference between left and right travel motors 48L, 48R, while straight travel may be facilitated by generating substantially equal output velocities and rotational directions from left and right travel motors 48L, 48R.

Similar to swing motor 44, each of left and right travel motors 48L, 48R may be driven by creating a fluid pressure differential. Specifically, each of left and right travel motors 48L, 48R may include first and second chambers (not shown) located to either side of an impeller (not shown). When the first chamber is filled with pressurized fluid and the second chamber is drained of fluid, the impeller may be urged to rotate a corresponding traction device in a first direction. Conversely, when the first chamber is drained of the fluid and the second chamber is filled with the pressurized fluid, the respective impeller may be urged to rotate the traction device in an opposite direction. The flow rate of fluid into and out of the first and second chambers may determine a rotational velocity of left and right travel motors 48L, 48R, while a pressure differential between the chambers may determine a torque.

Power source 18 may embody an engine such as, for example, a diesel engine, a gasoline engine, a gaseous fuel-powered engine, or any other type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic power for moving hydraulic cylinders 26, 32, 34 and left travel, right travel, and swing motors 48L, 48R, 44.

Operator station 20 may be configured to receive input from a machine operator indicative of a desired machine movement (e.g., implement and/or drive system movement). Specifically, operator station 20 may include one or more interface devices 50 embodied, for example, as single or multi-axis joysticks located proximate an operator seat (not shown). Interface devices 50 may be proportional-type controllers configured to position and/or orient machine 10 and/or work tool 14 by producing corresponding signals that are indicative of a desired velocities in particular directions. The signals may be used to actuate any one or more of hydraulic cylinders 26, 32, 34, swing motor 44, and or travel motors 48L, 48R.

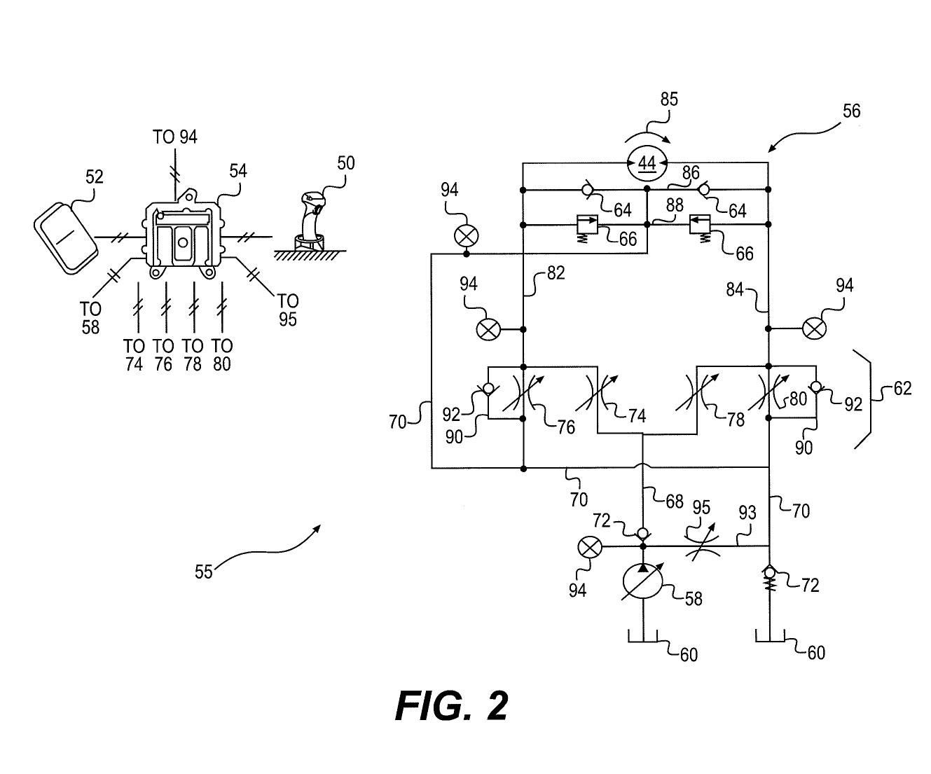

An additional interface device 52 (shown only in FIG. 2) may be included within operator station 20, and used to indicate a desired mode of operation. In the disclosed embodiment, interface device 52 is shown as a switch that is selectively manipulated by the operator of machine 10 to generate a corresponding mode signal. The mode signal may have a first value when interface device 52 is in a first or normal mode position, and a second value when interface device 52 is in a second or fine control mode position. The signals generated by interface devices 50, 52 may be directed to a controller 54 (shown only in FIG. 2) for further processing. It is contemplated that different interface devices may alternatively or additionally be included within operator station 20 such as, for example, wheels, knobs, push-pull devices, switches, pedals, and other operator interface devices known in the art.

For the purposes of this disclosure, the term “normal mode” may be considered the mode of operation that is intended by the manufacturer for use during a majority of the time that machine 10 is operated. This mode of operation may provide for high productivity and/or efficiency of machine 10. In contrast, the term “fine control mode” may be considered a mode of operation that is intended by the manufacturer for selective use during a minority of the time that machine 10 is operated. This mode of operation may provide for enhanced control of work tool 14 and/or machine 10 through slower and/or less forceful movements.

As illustrated in FIG. 2, machine 10 may include a hydraulic system 55 having a plurality of fluid components that cooperate to move work tool 14 (referring to FIG. 1) and machine 10. In the disclosed embodiment, hydraulic system 55 includes a circuit 56 configured to deliver a stream of pressurized fluid from a source 58 (e.g., a pump, an accumulator, or another source) to swing motor 44 and to transport waste fluid from the swing motor 44 to a low-pressure tank 60, to another actuator, or to an energy recovery circuit for storage and/or reuse, as desired. It should be noted that, although only swing motor 44 is shown in FIG. 2 as being fluidly connected to source 58 and tank 60, a different one or more of hydraulic cylinders 26, 32, 34, and travel motors 48L, 48R could be added to circuit 56 and/or replace swing motor 44 within circuit 56, as desired. It is further contemplated that an additional source of pressurized fluid may be connected to circuit 56, if desired.

Circuit 56 may include, among other things, a swing control valve 62, one or more makeup valves 64, and one or more relief valves 66. Swing control valve 62 may be connected to regulate a flow of pressurized fluid from source 58 to swing motor 44 via a supply passage 68, and from swing motor 44 to tank 60 via a drain passage 70. The supply of fluid to one chamber of swing motor 44 and the simultaneous draining of fluid from an opposing chamber of swing motor 44 may create a pressure differential across swing motor 44 that drives swing motor 44 to rotate and pivot work tool 14 about axis 42 (referring to FIG. 1). Makeup valves 64 may be configured to supply makeup fluid to a low-pressure chamber of swing motor 44, while relief valves 66 may be configured to relieve fluid from a high-pressure chamber of swing motor 44. One or more check valves 72 may be located within supply passage 68 (e.g., between source 58 and swing control valve 62) and/or drain passage 70 to facilitate unidirectional flows through these passages and/or to maintain desired pressures within circuit 56.

Swing control valve 62 may have elements that are movable to control the rotation of swing motor 44 and corresponding swinging motion of implement system 12. Specifically, swing control valve 62 may include a first chamber supply element 74, a first chamber drain element 76, a second chamber supply element 78, and a second chamber drain element 80 all disposed within a common block or housing (not shown). The first and second chamber supply elements 74, 78 may be connected in parallel with supply passage 68 and separately with first and second chamber passages 82, 84, respectively, to regulate filling of the chambers with fluid from source 58. Similarly, first and second chamber drain elements 76, 80 may be connected in parallel with drain passage 70 and separately with first and second chamber passages 82, 84, respectively, to regulate fluid draining of the chambers.

To drive swing motor 44 to rotate in a first direction (shown in FIG. 2 by an arrow 85), first chamber supply element 74 may be shifted to allow pressurized fluid from source 58 to enter the first chamber of swing motor 44 via supply passage 68 and first chamber passage 82, while second chamber drain element 80 may be shifted to allow fluid from the second chamber of swing motor 44 to drain to tank 60 via second chamber conduit 84 and drain passage 70. To drive swing motor 44 to rotate in the opposite direction, second chamber supply element 78 may be shifted to communicate the second chamber of swing motor 44 with pressurized fluid from source 58, while first chamber drain element 76 may be shifted to allow draining of fluid from the first chamber of swing motor 44 to tank 60. It is contemplated that both the supply and drain functions of swing control valve 62 (i.e., of the four different supply and drain elements) may alternatively be performed by a single valve element associated with the first chamber and a single valve element associated with the second chamber, if desired.

Supply and drain elements 74-80 of swing control valve 62 may be solenoid-movable against a spring bias in response to a flow rate or position command issued by controller 54. In particular, swing motor 44 may rotate at a velocity that corresponds with the flow rate of fluid into and out of the first and second chambers, and with a force that corresponds with a pressure differential between the first and second chambers. Accordingly, to achieve an operator-desired swing velocity, a command based on an assumed or measured pressure may be sent to the solenoids (not shown) of supply and drain elements 74-80 that causes them to open an amount corresponding to the necessary flow rate through swing motor 44. This command may be in the form of a flow rate command or a valve element position command that is issued by controller 54.

First and second cross passages 86, 88 may extend in parallel between first and second chamber passages 82, 84 and be fluidly communicated with drain passage 70. Makeup valves 64 may be disposed within first cross passage 86, while relief valves 66 may be disposed within second cross passage 88. Drain passage 70 may connect to first and second cross passages 86, 88 at locations between makeup valves 64 and between relief valves 66, respectively. In this configuration, a pressure differential between drain passage 70 and first and second chamber passages 82, 84 may either cause fluid to be discharged into drain passage 70 from first and/or second chamber passages 82, 84 (via relief valves 66) or fluid to be supplied into first and/or second chamber passages 82, 84 from drain passage 70 (via makeup valves 64), depending on the direction and magnitude of the pressure differential.

In the disclosed embodiment, a bypass passage 90 and a check valve 92 are associated with each of first and second chamber passages 82, 84. Check valve 92 may be selectively movable by an imbalance of pressure between drain passage 70 and first or second chamber passages 82, 84 to establish fluid communication therebetween for additional makeup purposes. It is contemplated that bypass passages 90 and check valves 92 may be omitted, if desired.

An additional bypass passage 93 may extend between supply passage 68 and drain passage 70, and a bypass valve 95 may be disposed within bypass passage 93. In this configuration, bypass valve 95 may be an independent metering valve (similar to supply and drain elements 74-80) that is configured to vary a restriction on the flow of fluid within bypass passage 93 in response to a command signal from controller 54, thereby regulating a pressure and/or flow rate of fluid in supply passage 68.

Controller 54 may be in communication with the different components of hydraulic system 55 to regulate operations of machine 10. For example, controller 54 may be in communication with the elements of swing control valve 62 in circuit 56, with bypass valve 95, and with other control valve elements (not shown) associated with the remaining hydraulic actuators of machine 10 (e.g., hydraulic cylinders 26, 32, 34, and travel motors 48L, 48R). Based on various operator input and monitored parameters, as will be described in more detail below, controller 54 may be configured to selectively activate the different control valves in a coordinated manner to efficiently carry out operator-requested movements of implement system 12.

Controller 54 may include a memory, a secondary storage device, a clock, and one or more processors that cooperate to accomplish a task consistent with the present disclosure. Numerous commercially available microprocessors can be configured to perform the functions of controller 54. It should be appreciated that controller 54 could readily embody a general machine controller capable of controlling numerous other functions of machine 10. Various known circuits may be associated with controller 54, including signal-conditioning circuitry, communication circuitry, and other appropriate circuitry. It should also be appreciated that controller 54 may include one or more of an application-specific integrated circuit (ASIC), a field-programmable gate array (FPGA), a computer system, and a logic circuit configured to allow controller 54 to function in accordance with the present disclosure.

The operational parameters monitored by controller 54, in the disclosed embodiment, include the pressures of fluid at various locations within circuit 56. For example, one or more pressure sensors 94 may be strategically located in fluid communication with an output of source 58, drain passage 70, first chamber passage 82, and/or second chamber passage 84 to sense a pressure of the respective passages and generate corresponding signals directed to controller 54 that are indicative of the pressures. It is contemplated that any number of pressure sensors 94 may be placed at any locations within circuit 56, as desired. It is further contemplated that other operational parameters such as, for example, velocities, temperatures, viscosities, densities, flow rates, etc. may also or alternatively be monitored and used to regulate operation of machine 10, if desired.

Controller 54 may be configured to regulate operation of hydraulic system 55 differently depending on activation of mode switch 52. For example, during the normal mode of operation, controller 54 may be configured to reference a first relationship map when commanding movements of swing control valve 62, and use a different second relationship map during the fine control mode of operation. In general, use of the second relationship map may result in more controlled (i.e., slower and/or less forceful) movements of work tool 14 and/or machine 10.

The maps may be stored in the memory of controller 54 and interrelate the interface device position signal(s), the corresponding desired work tool velocities, valve element positions, system pressures, and/or other characteristics of hydraulic system 55. Each of these maps may be in the form of tables, graphs, and/or equations. In one example, desired work tool velocity, system pressure(s), and/or corresponding flow rates may form the coordinate axis of a 2- or 3-D table for control of valve elements 74-80. The flow rates required to move swing motor 44 at the desired velocities and corresponding positions of the appropriate valve elements 74-80 may be related in the same or another separate 2- or 3-D map, as desired. It is also contemplated that desired velocity may be directly related to the valve element positions in a single 2-D map. Controller 54 may be configured to allow the operator to directly modify these maps and/or to select specific maps from available relationship maps stored in the memory of controller 54 to affect actuation of swing motor 44. It is also contemplated that the maps may be automatically selected for use by controller 54 based on sensed or determined modes of machine operation, if desired.

### INDUSTRIAL APPLICABILITY

The disclosed hydraulic system may be applicable to any machine having a hydraulic actuator, where fine control over actuator motions is selectively desired. Fine control may be provided by affecting valve positions and corresponding flow rates to slow the velocity and/or reduce the force of the actuator. This control may be implemented when manually requested by the operator or, in some embodiments, automatically based on detected use of interface device 50. Operation of hydraulic system 55 will now be described in detail.

During operation of machine 10 (referring to FIG. 1), a machine operator may manipulate operator interface device 50 to cause a corresponding movement of machine 10. For example, the operator may manipulate interface device 50 to initiate swinging of body 38 relative to undercarriage 40. The actuation position of interface device 50 may be related to an operator-expected or desired swing direction, velocity, and/or torque. Interface device 50 may generate a position signal indicative of the operator-expected or desired movement during manipulation thereof, and send this position signal to controller 54. At this same time, interface device 52 may either be in the normal mode position or in the fine control position, as selected by the operator of machine 10, and generate a corresponding mode signal.

Controller 54 may receive the position signal from interface device 50 and the mode signal from interface device 52, and determine commands for swing control valve 62 that correspond with the operator-desired movements of machine 10. Controller 54 may then command activation of swing control valve 62 to direct pressurized fluid from source 58 to swing motor 44 that results in movement in the manner desired by the operator.

When the mode signal indicates that interface device 52 is in the normal mode position, controller 54 may utilize the first map stored in memory to relate the position signal from interface device 50 to commands issued to the elements of swing control valve 62. For example, when interface device 50 is displaced in a first direction to a position about halfway between a neutral position and a maximum displaced position, interface device 52 may generate a corresponding position signal indicative of a desire for work tool 14 to swing in the first direction (indicated by arrow 85 in FIG. 2) at a velocity that is about 50% of a maximum velocity. In this situation, controller 54 may reference the position signal with the first map and determine position commands for first chamber supply element 74 and second chamber drain element 80 that produce the desired swing velocity. Specifically, controller 54 may cause first chamber supply element 74 and second chamber drain element 80 to move to about a 50% open position. First chamber drain element 76 and second chamber supply element 78 may be substantially closed at this time. Under these conditions, swing motor 44 should be caused to rotate in the first direction at a velocity that is about 50% of a maximum.

To swing work tool 14 in an opposing direction at a slower velocity, the operator of machine 10 may displace interface device 50 in a second direction, for example to a displacement position that is 25% from the neutral position to the maximum displaced position. In this situation, controller 54 may reference the corresponding position signal with the first map and determine position commands for second chamber supply element 78 and first chamber drain element 76 that produce the desired swing velocity. Specifically, controller 54 may cause second chamber supply element 78 and first chamber drain element 76 to move to about a 25% open position. Second chamber drain element 80 and first chamber supply element 74 may be substantially closed at this time. Under these conditions, swing motor 44 should be caused to rotate in the second direction at a velocity that is about 25% of the maximum.

When the mode signal indicates that interface device 52 is in the fine control mode position, however, controller 54 may utilize the second map stored in memory to relate the position signal from interface device 50 to commands issued to the elements of swing control valve 62. In one embodiment, the second map may call for second chamber supply element 78 to be opened to some degree simultaneously with first chamber supply and second chamber drain elements 74, 80. When second chamber supply element 78 is opened during rotation of swing motor 44 in the first direction (indicated by arrow 85 in FIG. 2), the pressure in the second chamber of swing motor 44 may be caused to increase. This increasing back pressure may result in a reduced pressure gradient across swing motor 44 and a corresponding lower force urging swing motor 44 to rotate, which may in turn result in a slower acceleration and lower velocity of swing motor 44. For example, although first chamber supply and second chamber drain elements 74, 80 may still open to their 50% positions based on the position signal from interface device 50, the increased back pressure in the second chamber of swing motor 44 may result in a swing velocity that is less than 50% of the maximum swing velocity. It should be noted that the opening of second chamber supply element 78 during rotation of swing motor 44 in the first direction may be sufficient only to decrease the pressure gradient across swing motor 44 by a specific amount, and not to reverse the pressure gradient. For this reason, controller 54 may closely monitor the pressures of hydraulic system 55 during operation (e.g., via sensors 94), and make adjustments, if necessary, to ensure that instabilities are not created by the fine control mode. The opening amount of second chamber supply element 78 and resulting reduction in pressure gradient may be selected by the manufacturer and based on machine type, model, and/or application. It is further contemplated that the opening amount may be tuned by the operator, if desired.

In another embodiment, when the mode signal indicates that interface device 52 is in the fine control mode position, referencing the second map during rotation of swing motor 44 in the first direction may alternatively result in first chamber drain element 76 opening simultaneously with first chamber supply and second chamber drain elements 74, 80. In this situation, some of the pressurized fluid from source 58 passing through first chamber supply element 74 may be routed directly through first chamber drain element 76 to tank 60 instead of into the first chamber of swing motor 44. That is, a lower flow rate of fluid and/or fluid having a lower pressure may be directed into the first chamber of swing motor 44 under these conditions. The lower flow rate and/or pressure may result in a reduced swing force and/or velocity of work tool 14, even though first chamber supply and second chamber drain elements 74, 80 may still be moved to their 50% positions. It is contemplated that the opening of first chamber drain element 76 during rotation of swing motor 44 in the first direction may be instituted alone or together with the opening of second chamber supply element 78 described above, such that the flow rate and/or pressure of fluid entering the first chamber of swing motor 44 may be reduced at the same time that the back pressure of the second chamber is increased. It should be noted that, in some embodiments, after interface device 50 has been returned to a neutral position while operating in the fine control mode, first and second chamber drain elements 76, 80 may still remain open for a specified amount of time necessary to more quickly equalize pressures across swing motor 44.

In yet another embodiment, when the mode signal indicates that interface device 52 is in the fine control mode of operation, referencing the second map during rotation of swing motor 44 in the first direction may alternatively result in a reduced opening amount of first chamber supply and/or second chamber drain elements 74, 80. For example, when interface device 50 generates the position signal indicative of a 50% displaced position, first chamber supply and/or second chamber drain elements 74, 80 may be caused to open by a lesser amount, for example about 25%. In this situation, swing motor 44 may receive only about one-half of the normal flow rate of fluid for the given position of interface device 50 and, accordingly rotate at about one-half of the normal velocity. It is contemplated that this strategy may be implemented alone or, alternatively, in conjunction with another strategy, if desired.

In a final embodiment, when the mode signal indicates that interface device 52 is in the fine control mode, referencing the second map during rotation of swing motor 44 in the first direction may alternatively result in opening of bypass valve 95. For example, when interface device 50 generates the position signal indicative of a 50% displaced position, bypass valve 95 may be caused to divert pressurized fluid from source 58 directly to tank 60, thereby reducing a flow rate of fluid and/or pressure of fluid passing through first chamber supply element 74. In this situation, swing motor 44 may receive a reduced flow rate of fluid and/or fluid at a reduced pressure for the given position of interface device 50 and, accordingly, rotate at a reduced velocity and/or with reduced force.

In any one or more of the embodiments described above, controller 54 may also be capable of adjusting the output of pump 58 differently during the fine control mode of operation. For example, controller 54 could reduce the displacement of pump 58 during the fine control mode for a given signal from interface device 50. This displacement reduction may result in a lower supply pressure and/or supply rate of fluid, consequently causing swing motor 44 to move at a slower rate and/or with less force.

It is contemplated that, in some situations, it may be helpful to cause machine 10 to automatically operate in the fine control mode, even if not manually requested by the operator. For example, when the operator of machine 10 manipulates interface device 50 by only small amounts, it may be concluded that the operator is attempting to precisely control movements of work tool 14. In these situations, controller 54 may utilize the second map to regulate swing control valve 62 regardless of the actuation position of interface device 52. In one embodiment, controller 54 may use the second map only when the displacement position of interface device 50 is less than a threshold amount (e.g., less than about 10% of its range) and/or moved at a velocity that is less than a threshold rate (e.g., less than 1% per second).

The disclosed hydraulic system may enhance performance of machine 10. In particular, by selectively slowing down and/or reducing the forcefulness of machine movements, the movements may be more controllable. By increasing control over the movements of machine 10, accuracy and efficiency of particular tasks, such as tool coupling or craning, may be improved.

It will be apparent to those skilled in the art that various modifications and variations can be made to the disclosed hydraulic system. Other embodiments will be apparent to those skilled in the art from consideration of the specification and practice of the disclosed hydraulic system. For example, although operation of hydraulic system 55 has been described with respect to swing motor 44, it is contemplated that similar fine control over work tool movements may be provided via similar regulation of hydraulic cylinders 26, 32, 34 and/or left and right travel motors 48L, 48R, if desired. In addition, although the examples provided above focus on rotation of swing motor 44 in the first direction, controller 54 may similarly regulate operation of hydraulic system 55 in the second direction. It is intended that the specification and examples be considered as exemplary only, with a true scope being indicated by the following claims and their equivalents.

What is claimed is:

1. A hydraulic system for a machine, comprising:
a hydraulic actuator having a first chamber and a second chamber;
at least one valve configured to regulate fluid flows associated with the first and second chambers;
an operator interface device movable through a range from a neutral position to a maximum displaced position to generate a corresponding position signal indicative of a desired movement of the hydraulic actuator;
a mode switch movable to generate a mode signal indicative of desired operation in one of a normal control mode and a fine control mode; and
a controller in communication with the at least one valve, the operator interface device, and the mode switch, the controller being configured to:
move the at least one valve to a first position based on the position signal when the mode signal indicates desired operation in the normal mode; and
move the at least one valve to a second position based on the position signal when the mode signal indicates desired operation in the fine control mode.

2. The hydraulic system of claim 1, wherein:
the at least one valve at least one includes at least two valve elements associated with filling and draining functions of the hydraulic actuator; and
the controller is configured to:
move at least one of the at least two valve elements to a first position based on the position signal when the mode signal indicates desired operation in the normal mode; and
move the at least one of the at least two valve elements to a second position based on the position signal when the mode signal indicates desired operation in the fine control mode.

3. The hydraulic system of claim 2, wherein:
the at least two valves elements includes a first chamber supply element, a first chamber drain element, a second chamber supply element, and a second chamber drain element; and
the controller is configured to:
move the first and second chamber supply and drain elements to first positions based on the position signal when the mode signal indicates desired operation in the normal mode; and
move the first and second chamber supply and drain elements to second positions based on the position signal when the mode signal indicates desired operation in the fine control mode.

4. The hydraulic system of claim 3, wherein the controller is configured to move one of the first and second chamber drain elements to increase a backpressure of the hydraulic actuator when the mode signal indicates desired operation in the fine control mode.

5. The hydraulic system of claim 4, wherein the controller is configured to move one of the first and second chamber drain elements to decrease at least one of a flow rate and a pressure of fluid supplied to the hydraulic actuator when the mode signal indicates desired operation in the fine control mode.

6. The hydraulic system of claim 5, wherein the controller is configured to move both of the first and second chamber drain elements to simultaneously increase a backpressure of the hydraulic actuator and to decrease at least one of a flow rate and a pressure of fluid supplied to the hydraulic actuator when the mode signal indicates desired operation in the fine control mode.

7. The hydraulic system of claim 3, wherein the controller is configured to move one of the first and second chamber supply elements to increase a backpressure of the hydraulic actuator when the mode signal indicates desired operation in the fine control mode.

8. The hydraulic system of claim 7, wherein the controller is configured to move one of the first and second chamber drain elements to decrease at least one of a flow rate and a pressure of fluid supplied to the hydraulic actuator when the mode signal indicates desired operation in the fine control mode.

9. The hydraulic system of claim 8, wherein the controller is configured to both move one of the first and second chamber supply elements to increase a backpressure of the hydraulic actuator and to simultaneously move one of the first and second drain elements to decrease at least one of a flow rate and a pressure of fluid supplied to the hydraulic actuator when the mode signal indicates desired operation in the fine control mode.

10. The hydraulic system of claim 1, wherein:
the at least one valve includes a bypass valve disposed within a passage that extends between a source of pressurized fluid and a low-pressure tank; and
the controller is configured to move the bypass valve to an open position when the mode signal indicates desired operation in the fine control mode.

11. The hydraulic system of claim 1, wherein the controller includes stored in memory a first map associated with the normal mode and a second map associated with the fine control mode, each of the first and second maps relating the position signal to commands used by the controller to move the at least one valve.

12. The hydraulic system of claim 11, wherein the controller is configured to automatically select the second map for use when the operator interface device is displaced to a position within the range that is less than a threshold position regardless of the mode signal.

13. A method of controlling a hydraulic tool of a machine, comprising:
receiving a first operator input indicative of a desired velocity of the work tool;
receiving a second operator input indicative of desired operation in one of a normal control mode and a fine control mode;
moving at least one control valve associated with fluid flow of an actuator of the hydraulic tool to a first position based on the first operator input when the second operator input is indicative of desired operation in the normal control mode; and
moving the at least one control valve to a second position based on the first operator input when the second operator input is indicative of desired operation in the fine control mode.

14. The method of claim 13, wherein moving the at least one control valve to the second position increases a backpressure of a hydraulic actuator associated with the work tool.

15. The method of claim 13, wherein moving the at least one control valve to the second position decreases at least one of a flow rate and a pressure of fluid supplied to a hydraulic actuator associated with the work tool.

16. The method of claim 13, wherein moving the at least one control valve to the second position both increases a back pressure of the hydraulic actuator and decreases at least one of a flow rate and a pressure of fluid supplied to a hydraulic actuator associated with the work tool.

17. The method of claim 13, wherein the at least one control valve includes a bypass valve disposed within a passage that extends between a source of pressurized fluid and a low-pressure tank.

18. The method of claim 13, further including referencing a first map associated with the normal mode and a second map associated with the fine control mode to determine commands used to move the at least one control valve, each of the first and second maps relating the first operator input to commands used to move the at least one control valve.

19. The method of claim 18, further including automatically selecting the second map for use when the first operator input indicates desired velocity of the hydraulic actuator less than a threshold amount.

20. A machine, comprising:
an engine;
an undercarriage drive by the engine to propel the machine;
a body;
a swing motor configured to swing the body relative to the undercarriage;
a tank;
a pump driven by the engine to draw fluid from the tank, pressurize the fluid, and direct the pressurized fluid to the swing motor;
a plurality of valves configured to regulate fluid flows between the pump and the swing motor and between the swing motor and the tank;
an operator interface device configured to generate a position signal indicative of a desired velocity of the swing motor;
a mode switch configured to generate a mode signal indicative of desired operation in one of a normal control mode and a fine control mode; and
a controller in communication with the plurality of valves, the operator interface device, and the switch, the controller being configured to:
receive the position and mode signals;
reference a first control map stored in memory to determine a desired position of at least one of the plurality of valves based on the position signal when the mode signal is indicative of desired operation in the normal mode;
reference a second control map stored in memory to determine the desired position of the at least one of the plurality of valves based on the position signal when the mode signal is indicative of desired operation in the fine control mode; and
command movement of the at least one of the plurality of valves to the desired position.
